(19) United States
(12) Patent Application Publication
(10) Pub. No.: US 2003/0202526 A1
(43) Pub. Date: Oct. 30, 2003

(54) Methods and devices for simplifying the control and management of quality of service levels

(76) Inventors: Thomas A. Hoch, Boxborough, MA (US); Raymond J. Schmidt JR., Stoughton, MA (US)

Correspondence Address: John E. Curtin, Esq., Troutman Sanders LLP, Suite 600, 1660 International Drive, McLean, VA, 22102, US

(21) Appl. No.: 10/128,423

(22) Filed: Apr. 24, 2002

(51) Int. Cl. H04L 12/28; H04L 12/56

(52) U.S. Cl. 370/412; 370/428; 370/395.21

(57) ABSTRACT

The control and management of Quality of Service (“QOS”) levels within a communications system is simplified by reducing the complexity of the control section. Instead of having individual control sections dedicated to each QOS level, one control section is used in conjunction with a number of QOS counters to manage a plurality of QOS levels.

### BACKGROUND OF THE INVENTION

Today's telecommunications companies offer a wide range of services. Internally, these services must be managed using hardware, software or some combination of the two. One common design is to use a plurality of “first-in, first-out” (“FIFO”) counters. Referring to FIG. 1 there is shown a number of FIFO counters 1, 2, 3 . . . m, where m is the last counter. Collectively, these counters 1, 2, 3 . . . m are commonly referred to as a “buffer” 10. Each FIFO 1, 2, 3 . . . m can be thought of as comprising two separate elements: a counter and a control section. For example, FIFO 1 comprises counter 1A and control section 1B. As illustrated in the simplified buffer 10 shown in FIG. 1, existing designs require a separate control section for each “Quality of Service” (“QOS”) level.

Each time information, usually in the form of a “packet”, is received by the buffer 10 via pathway 11 the buffer 10 is adapted to identify the various QOS levels that are in each packet using techniques known in the art, e.g., the QOS level is identified by reading the “header tag” present within each packet.

This existing design has its drawbacks. First, because each QOS level requires its own control section the number of sections can grow to the point where the design of a buffer becomes quite complex. Second, the more FIFOs that are needed, the more space is needed and, therefore, the larger the semiconductor area (e.g., silicon) required.

Accordingly, it is a desire of the present invention to simplify the management and control of QOS levels.

It is a further desire of the present invention to reduce the amount of semiconductor material (i.e., silicon chip area) needed for QOS level control.

Further desires will become apparent from the drawings, detailed description of the invention and claims which follow.

### BRIEF DESCRIPTION OF THE DRAWINGS

FIG. 1 depicts a simplified block diagram of an existing technique for managing/controlling QOS levels.

FIG. 2 depicts a simplified block diagram of a technique for managing/controlling QOS levels according to one embodiment of the present invention.

### SUMMARY OF THE INVENTION

In accordance with the present invention, there are provided devices and methods for simplifying the control and management of QOS levels.which comprise reducing the number of control sections used to identify QOS levels. Instead of dedicating one control section to each QOS level, one control section and a number of less complex counters are used for a multitude of QOS levels.

### DETAILED DESCRIPTION OF THE INVENTION

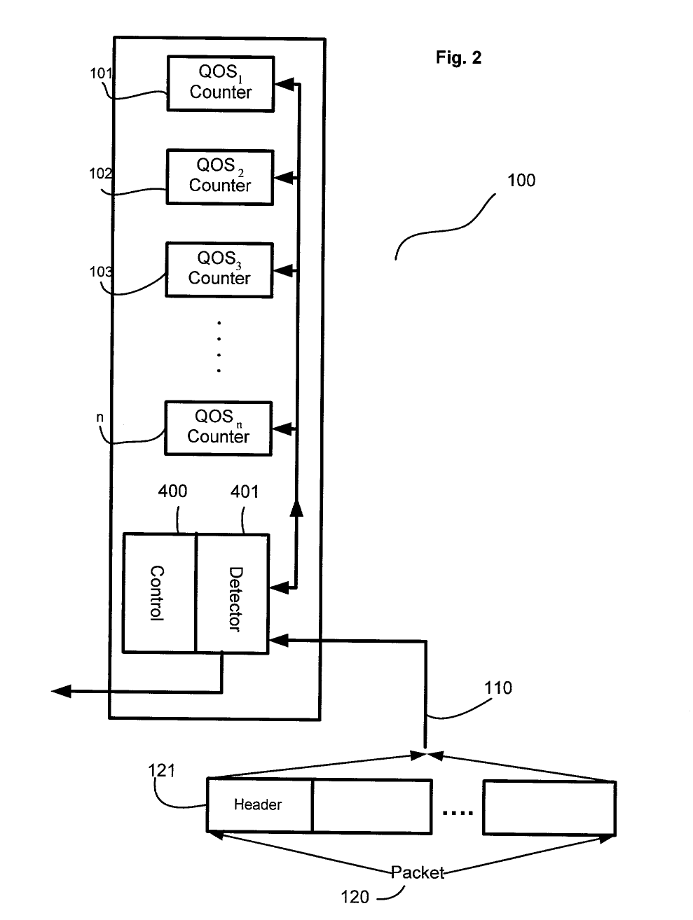

Referring to FIG. 2, there is shown a device 100 adapted to manage/control QOS levels according to one embodiment of the present invention. The device 100 may comprise a switch or a buffer to give just a few examples. As shown, the device 100 comprises a plurality of QOS counters 101, 102, 103 . . . n where n is the last counter. In addition, in the example shown in FIG. 2, the device 100 comprises a control section 400. In one embodiment of the present invention, each of the counters 101, 102, 103 . . . n is associated with one QOS level. More specifically, each counter 101, 102, 103 . . . n is adapted to store a value associated with a QOS level. One example of the operation of the device 100 is as follows.

Communication signals (e.g., packets) are received by the device 100 via pathway 110. An overly simplified, typical packet 120 is shown in FIG. 2. Within packet 120 there is a header section 121 which includes data which identifies or indicates the QOS level associated with the packet 120. After device 100 receives each packet via pathway 110, it is adapted to detect the QOS level indicated within each header section. There are many ways to detect the QOS level associated with each packet. The detection may be carried out by the control section 400 or by a separate detection section 401. Once the device 100 has detected the QOS level of packet 120 the control section 400 is adapted to change, e.g., increment, a value stored within one of the QOS counters 101, 102, 103 . . . n associated with the detected or identified QOS level. In one embodiment of the present invention, each counter 101, 102, 103 . . . n is dedicated to a single QOS level.

When the packet 120 is output from the device 100 the QOS level of the packet is once again detected. Thereafter, the control section 100 is adapted to change, e.g., decrement, the value stored in the QOS counter 101, 102, 103 . . . n associated with the particular QOS level.

It should be understood that the counters 101, 102, 103 . . . n and sections 400,401 may be implemented in hardware, software or some combination of the two. Though shown as separate units, the counters 101, 102, 103 . . . n, control section 400 and detection section 401 may be combined into fewer units or, alternatively, further broken down into additional units.

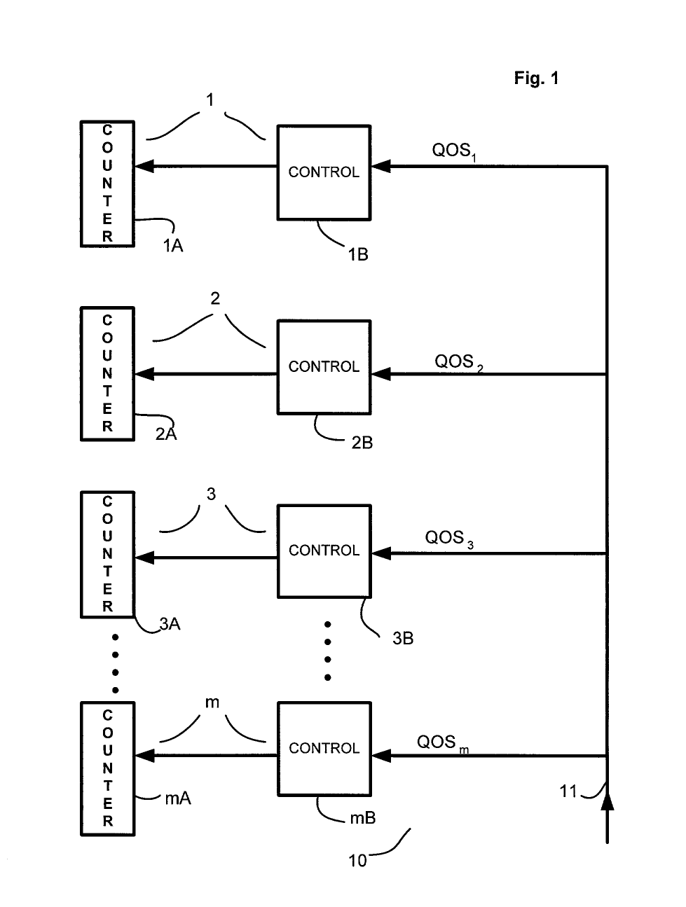

Comparing FIG. 1 with FIG. 2, it can be seen that the number of control sections is decreased. This allows for a reduction in the amount of area required on a semiconductor chip. It also allows a reduction in the complexity of the control section needed to manage QOS levels.

The discussion above has attempted to present some examples of the ideas embodied in the present invention. Others may be envisioned without departing from the spirit and scope of the present invention which is defined by the claims that follow.

We claim:

1. A device for managing QOS levels comprising:
a plurality of QOS counters, each counter associated with a QOS level and each counter adapted to store a value associated with a QOS level; and
a control section adapted to change the values stored within the QOS counters upon detection of the QOS levels.

2. The device as in claim 1 wherein the device comprises a buffer.

3. The device as in claim 1 further comprising a detection section for detecting the QOS levels.

4. The device as in claim 1 wherein the control section is further adapted to increment a value upon detection of a QOS level input into the device and decrement the value upon detection of the QOS level output from the device.

5. A method for managing QOS levels comprising:
storing values associated with QOS levels within a plurality of QOS counters, each counter associated with one QOS level; and
changing the values stored within the QOS counters upon detection of the QOS levels.

6. The method as in claim 5 further comprising detecting the QOS levels.

7. The method as in claim 5 further comprising incrementing the values upon detection of input QOS levels and decrementing the values upon detection of output QOS levels.
